(19) United States
(12) Patent Application Publication
(10) Pub. No.: US 2025/0070933 A1
(43) Pub. Date: Feb. 27, 2025

(54) METHODS FOR ENABLING COMMUNICATION BETWEEN A NETWORK NODE AND A DISCOVERABLE WIRELESS DEVICE, A RELATED NETWORK NODE AND RELATED WIRELESS DEVICE

(71) Applicant: Sony Group Corporation, Tokyo (JP)

(72) Inventors: Erik BENGTSSON, Eslöv (SE); Jose FLORDELIS, Lund (SE); Fredrik RUSEK, Eslöv (SE); Olof ZANDER, Södra Sandby (SE); Kun ZHAO, Malmö (SE); Chaitanya TUMULA, Åkarp (SE); Zhinong YING, Lund (SE)

(21) Appl. No.: 18/719,234

(22) PCT Filed: Dec. 13, 2022
(86) PCT No.: PCT/EP2022/085570

§ 371 Date: Jun. 12, 2024

(30) Foreign Application Priority Data
Dec. 23, 2021 (SE) 2151615-8

(51) Int. Cl. H04L 5/00; H04W 8/00; H04W 56/00

(52) U.S. Cl. CPC H04L 5/0048; H04L 5/0053; H04W 8/005; H04W 56/0045

(57) ABSTRACT

A method is disclosed, performed by a network node, for enabling communication with a discoverable WD. The method comprises transmitting, to an aiding WD, a configuration message. The configuration message configures the aiding WD to transmit a Synchronization Signal Block (SSB) signal. The SSB signal being indicative of an Uplink (UL) resource for communicating a response to the SSB signal.

The present disclosure pertains to the field of wireless communications. The present disclosure relates to methods for enabling communication between a network node and a wireless device, a related network node, a related discoverable device and a related aiding wireless device.

### BACKGROUND

In the 3^{rd} Generation Partnership Program (3GPP) Massive Multiple Input Multiple Output (MaMi) systems, a network node, such as a gNB, is equipped with massive numbers of antennas (typically >64 antennas), which enables large antenna array gain. To take advantage of the larger antenna array gains available, the network node may have to identify an optimal precoder of the antenna array for each individual wireless device communicating with the network node. In Time Division Duplex (TDD) systems, the network node may, based on channel reciprocity and pilot signals from a wireless device, compute the optimal precoder.

A challenge associated with the MaMi system is how to set up a link between the network node and the wireless device. The wireless device needs to transmit a pilot signal but is not allowed to do so until it has received a synchronization signal with associated resources from the network node, as the wireless device needs to know when the network node listens for the signal. In general, any broadcasted signal is subject to lower antenna array gain in such systems, since the network may rely on codebook based precoders for the broadcasted signal.

A wireless device that is not yet connected to the network node and experiences weak signal conditions and/or a high interference level, may thus not be able to detect synchronization signals from the network node and may therefore not be able to connect to the network node.

### SUMMARY

Accordingly, there is a need for devices and methods for enabling communication between a WD and a network node, which may mitigate, alleviate or address the shortcomings existing and may provide an improved discovery procedure of a WD experiencing weak signal conditions and/or high interference levels.

A method is disclosed, performed by a network node, for enabling communication with a discoverable WD. The method comprises transmitting, to an aiding WD, a configuration message. The configuration message configures the aiding WD to transmit a Synchronization Signal Block (SSB) signal. The SSB signal being indicative of an Uplink (UL) resource, such as a Random-Access Channel (RACH) resource, for communicating a response to the SSB signal.

Further, a network node is provided, the network node comprising memory circuitry, processor circuitry, and a wireless interface, wherein the network node is configured to perform any of the methods disclosed herein and relating to the network node.

It is an advantage of the present disclosure that the network node can configure an aiding WD, such as a WD connected to the network node, to transmit SSB signals in dedicated resources. The aiding WD may thereby aid unconnected WDs, such as WDs that are not connected to the network node, in areas where the antenna array gain of the network node is sufficient only if an optimal precoder is used, such as in areas with weak signal conditions or areas with high interference level. Since, the SSBs transmitted by the aiding WD comprise synchronization signals and an indication of UL resources like the traditional SSBs transmitted by the network node, a discoverable WD receiving the SSB from the signal may use the information in the SSB signal to transmit signals to the network node in response to the SSB signals received from the aiding WD. This can enable a link to be set up between the network node and the discoverable WD and allows the network node to determine an optimal precoder to be used in the communication with the discoverable WD.

A method is disclosed, performed by an aiding WD, for enabling communication between a network node and a discoverable WD. The method comprises receiving, from the network node, a configuration message. The configuration message configures the aiding WD to transmit an SSB signal. The SSB signal being indicative of an UL resource for communicating a response to the SSB signal. The method comprises transmitting the SSB signal based on the received configuration message.

Further, an aiding wireless device is provided, the aiding WD comprising memory circuitry, processor circuitry, and a wireless interface, wherein the aiding wireless device is configured to perform any of the methods disclosed herein and relating to the aiding WD.

It is an advantage of the present disclosure that a coverage of SSB signal can be improved. The aiding WD can be configured to transmit SSB signals in dedicated resources. The aiding WD may thereby aid discoverable, such as unconnected, WDs in areas where the antenna array gain of the network node is only sufficient if an optimal precoder is used, such as in areas with weak signal conditions or areas with high interference level. Since the SSBs transmitted by the aiding WD comprise synchronization signals and an indication of UL resources like the traditional SSBs transmitted by the network node, a discoverable WD receiving the SSB from the aiding WD may use the information in the SSB signal to transmit signals to the network node in response to the SSB signal received from the aiding WD. This can enable a link to be set up between the network node and the discoverable WD and allows the network node to determine an optimal precoder to be used in the communication with the discoverable WD.

A method is disclosed, performed by a discoverable WD, for enabling communication between the discoverable WD and a network node. The method comprises receiving an SSB signal, the SSB signal being indicative of an UL resource for communicating a response to the SSB signal. The method comprises determining that the SSB signal was transmitted by an aiding WD. The method comprises transmitting, using the UL resource, one or more radio frequency signals.

Further, a discoverable wireless device is provided, the discoverable WD comprising memory circuitry, processor circuitry, and a wireless interface, wherein the discoverable WD is configured to perform any of the methods disclosed herein and relating to the discoverable WD.

It is an advantage of the present disclosure that a coverage of SSB signal can be improved. The discoverable WD may receive SSB signals from the aiding WD in areas where the antenna array gain of the network node is not sufficient to transmit the SSB signal to the discoverable WD unless an optimal precoder is used, such as in areas with weak signal conditions or areas with high interference level. Since the SSBs transmitted by the aiding WD comprise synchronization signals and an indication of UL resources like the traditional SSBs transmitted by the network node, the discoverable WD receiving the SSB from the aiding WD may use the information in the SSB signal to transmit signals, such as reference signals, in the indicated UL resource to the network node in response to the SSB signal received from the aiding WD. Transmitting the signals in response to the SSB in the UL resource indicated by the network node can enable a link to be set up between the network node and the discoverable WD. Transmitting the signals in the indicated UL resource further can allow the network node to determine an optimal precoder to be used in the communication with the discoverable WD and thereby can enable a communication between the discoverable WD and the network node even though the discoverable WD is located in areas with weak signal conditions or areas with high interference level.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example wireless communication system comprising an example network node and an example wireless device according to this disclosure,

FIG. 2 is a signaling diagram illustrating an example message exchange for enabling communication between a network node and a discoverable WD according to this disclosure,

FIG. 3 is a flow-chart illustrating an example method, performed in a network node, for enabling communication between a network node and a discoverable WD according to this disclosure,

FIG. 4 is a flow-chart illustrating an example method, performed in an aiding WD of a wireless communication system, for enabling communication between a network node and a discoverable WD according to this disclosure,

FIG. 5 is a flow-chart illustrating an example method, performed in a discoverable WD of a wireless communication system, for enabling communication between a network node and a discoverable WD according to this disclosure,

FIG. 6 is a block diagram illustrating an example network node according to this disclosure,

FIG. 7 is a block diagram illustrating an example aiding wireless device according to this disclosure, and

FIG. 8 is a block diagram illustrating an example discoverable wireless device according to this disclosure.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

A connected mode may be referred to as an operation mode wherein a data transmission can be communicated e.g. between the wireless device and a network node or between the wireless device and another wireless device. A connected mode may be referred to as an operation state wherein a radio transmitter and/or a radio receiver is activated for such communication. A connected mode may be referred to as an operation state wherein the wireless device is synchronized time-wise and/or frequency-wise e.g. by a determined timing advance parameter for the communication. In certain communication systems, a connected mode may be referred to as a radio resource control (RRC) state. In various examples, an active state may be a RRC connected state and/or an RRC active state. However, a connected mode may be an active period within another RRC state.

The dormant mode is a mode where the wireless device has no active connection with the network node. A dormant mode may be seen as an inactive mode of the wireless device. A dormant mode may be seen as a mode where the wireless device is unsynchronized with a timing of a network. In one or many examples the wireless device may be in a dormant mode not having valid timing advance information with respect to the network node. A dormant mode may be seen as a mode where the wireless device is unable to receive dedicated signaling. A dormant mode may be seen as a mode where closed loop power control is inactivated or suspended. Dormant mode may comprise RRC idle mode, RRC suspend and/or RRC inactive mode. For example, the wireless device may be in dormant mode when the connection with the network node has been released and/or suspended.

The figures are schematic in nature and simplified for clarity, and they merely show details which aid in understanding the disclosure, while other details have been left out. Throughout, the same reference numerals are used for identical or corresponding parts.

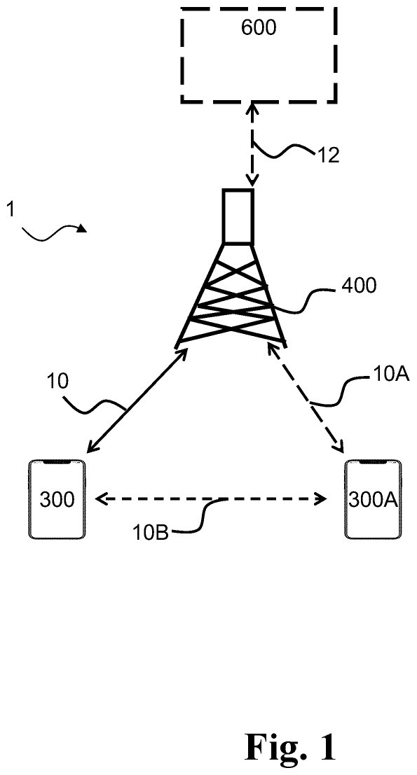

FIG. 1 is a diagram illustrating an exemplary wireless communication system 1 comprising an exemplary network node 400, an exemplary wireless device 300 and an exemplary wireless device 300A according to this disclosure.

As discussed in detail herein, the present disclosure relates to a wireless communication system 1 comprising a cellular system, such as a 3GPP wireless communication system.

The wireless communication system 1 comprises a wireless terminal 300, a wireless terminal 300A, a network node 400 and a core network node 600.

A network node 400 disclosed herein may refer to a radio access network node operating in the radio access network, such as a base station, an evolved Node B (eNB), a 5G radio access network node referred to as a gNB or a repeater, or a Non-Terrestrial Network (NTN) node, such as a satellite. An eNB or gNB may comprise one or more transmission point(s), TRP(s). Depending on the operating carrier frequency, a gNB may be operated with single or multiple beam transmission. Single beam is often referred as omni-directional, or quasi-omnidirectional, transmission and typically used in lower frequencies (such as Frequency Range 1 in 5G New Radio). Multiple beams are typically used in Frequency Range 2 (FR2) (24 GHZ and above) and/or Frequency Range 1 (FR1), such as for massive MIMO base stations, in order to compensate for path-loss. Multiple beams may consist of multiple narrow beams. A narrow beam typically has a higher gain than a single beam with omni-directional transmission.

The wireless communication system 1 described herein may comprise one or more wireless devices 300, 300A, and/or one or more network nodes 400, such as one or more of: a base station, an eNB, a gNB and/or an access point.

A core network node 600 disclosed herein may refer to a Location Server (LS), a Location Management Function (LMF) or an evolved Serving Mobile Location Center (e-SMLC). In some examples the core network node 600 and the network node 400 may be separate nodes or collocated nodes.

A wireless device 300, 300A may refer to a wireless terminal, a mobile device and/or a user equipment (UE).

The wireless devices 300, 300A may be configured to communicate with the base station 400 via a wireless link (or radio access link) 10, 10A, such as via a 3GPP air interface between a 5G UE and a 5G RAN, such as a Uu interface.

The network node 600 may be configured to communicate with the base station 400 and/or the wireless terminal 300, 300A via link 12.

The wireless devices 300, 300A may, in one or more examples, be configured to communicate with each other via a wireless link 10B. In one or more example networks, the wireless link 10B may use a different, radio protocol than the radio protocol used for the wireless link 10, 10A, such as a sidelink, which can also be known as a 3GPP PC5 interface. In one or more example networks, the wireless link 10B may use the same radio protocol as the radio protocol used for the wireless link 10, 10A, such as a Uu protocol. In one or more examples such wireless link 10B may operate on an unlicensed/shared frequency band.

In one or more example communication networks, the WD 300A may not be connected, such as may be unconnected, to the network node 400 and may have to connect to the network node 400 to communicate with the network node 400. The unconnected WD 300A may herein be referred to as a discoverable WD. Although not connected to the network node 400, the discoverable WD 300A may be connected to a network node different than the network node 400. The discoverable WD 300A may be a WD experiencing weak signal conditions or a high interference level, causing the discoverable WD to not be able to detect synchronization signals, such as SSBs, transmitted from the network node 400.

According to the current disclosure, a WD that is already connected to the network node 400, such as the WD 300 may aid the system by being configured by the network node 400 to transmit SSBs to the discoverable WD 300A in dedicated resources. The connected WD, such as the WD 300, may herein be referred to as an aiding WD. Thereby the aiding WD 300 may aid WDs in areas where the antenna array gain of the network node 400 is sufficient only if an optimal precoder is used (such as due to weak signal conditions or areas with high interference level). The antenna array gain may be defined as a ratio of the intensity in a given direction to the radiation intensity that would be obtained if the same power would be radiated using a single omnidirectional antenna. The SSBs transmitted by the aiding WD 300 may (like the traditional SSBs transmitted by the network node) comprise synchronization signals and an indication of UL resources for communicating the response to the SSB signal (such as where and when to transmit UL signals in response to receiving the SSB signal).

The aiding WD 300 may be configured by the network to transmit SSB signals in dedicated resources, such as via a predefined interface. The predefined interface may, in one or more example methods, use a Uu protocol to transmit the SSB signals. In one or more example methods, the predefined interface may be a modified Uu interface. The predefined interface may be different than a sidelink interface, such as a PC5 interface.

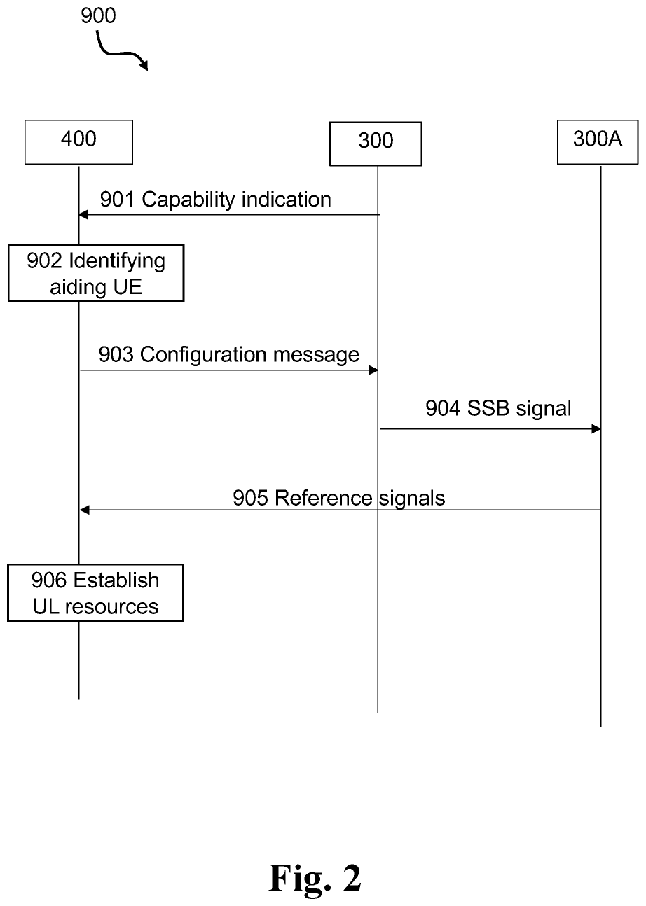

FIG. 2 is a signaling diagram illustrating an example message exchange 900 between the network node 400, the aiding WD 300, and the discoverable WD 300A for enabling communication between the discoverable WD and a network node according to one or more example methods disclosed herein. The aiding WD may be a WD that is connected to the network node 400.

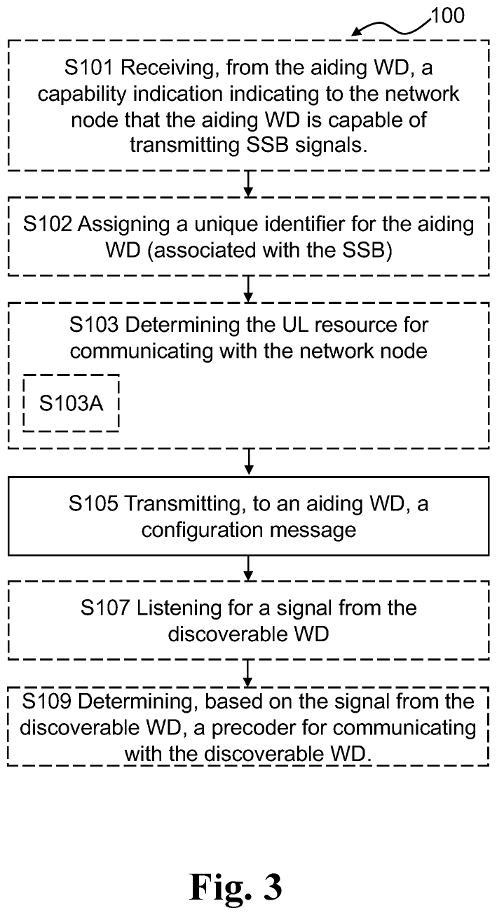

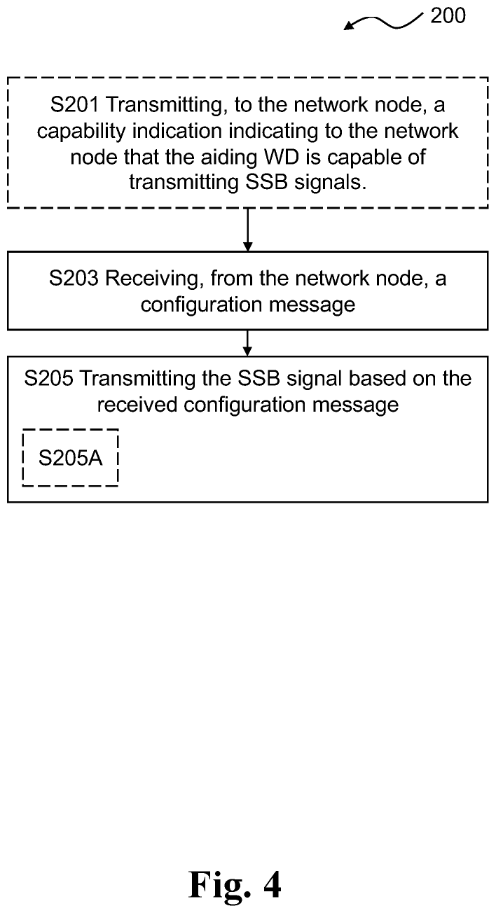

In one or more example methods, the aiding WD 300 may transmit a capability indication 901 indicating to the network node 400 that the aiding WD is capable of transmitting SSB signals. In one or more example methods, the capability indication may indicate that the aiding WD is capable of transmitting SSB signals via a predefined interface. The capability indication 901 corresponds to the capability indication received by the network node in S101 of FIG. 3 and transmitted by the aiding WD in S201 of FIG. 4.

The network node 400 may receive capability indications from a plurality of WDs 300 and may, based on the received capability indications, identify 902 an aiding WD 300 to aid a discoverable WD. The aiding WD may be identified and may be configured to transmit an SSB comprising an ID for identifying the SSB. The SSB may comprise information about the total number of SSBs in an SSB burst. Thereby, a receiving WD, such as a discoverable WD, can determine the position of the SSB signal in the burst. The network node 400 may further associate different SSB signals to the same or to different UL resources, such as RACH resources.

The network node 400 may transmit to the aiding WD, a configuration message 903. The configuration message configures the aiding WD to transmit an SSB signal. The SSB signal is indicative of the UL resource for communicating a response to the SSB signal. The UL resource may be a RACH resource, such as a RACH resource for preamble (Msg1) transmission. The configuration message 903 corresponds to the configuration message transmitted by the network node in S103 of FIG. 3 and received by the aiding WD in S203 of FIG. 4.

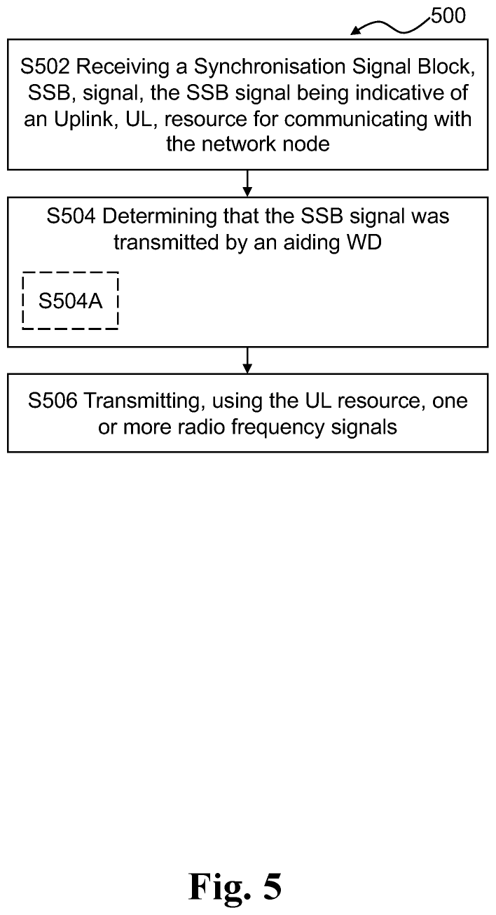

The aiding WD 300 may, based on the configuration message 903, transmit an SSB signal 904. The SSB signal 904 may be transmitted via the predefined interface, such as may be broadcasted via the predefined interface. The SSB signal 904 is indicative of the UL resource for communicating with the network node. The SSB signal 904 corresponds to the SSB signal transmitted by the aiding WD in S205 of FIG. 4 and received by the discoverable WD in S502 of FIG. 5.

The discoverable WD 300A may receive the SSB signal 904 from the aiding WD 300 and may transmit one or more signals 905, such as reference signals, to the network node 400 in the UL resource indicated by the SSB. The signal 905 corresponds to the signal transmitted by the discoverable WD in S506 of FIG. 5 and received by the network node in S107 of FIG. 3.

Based on the received signal 906, the network node 400 may establish resources 906 for communicating with the discoverable WD 300A. Establishing the resources may comprise identifying an optimal precoder for communicating with the discoverable WD 300A, such as a DL resource for communicating with the WD 300A.

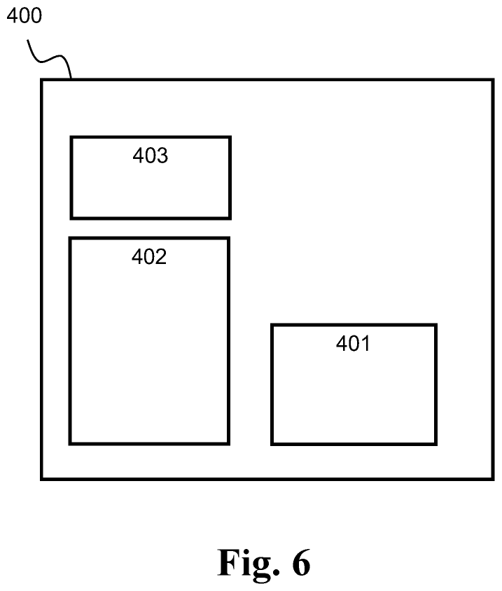

FIG. 3 shows a flow diagram of an example method 100, performed by a network node according to the disclosure, for enabling communication with a discoverable wireless device (WD). A discoverable WD herein is a WD that is not connected, such as unconnected, to the network node performing the method 100. The discoverable WD may however be connected to a network node different than the network node performing the method 100. The discoverable WD may be a WD experiencing weak signal conditions or a high interference level, causing the discoverable WD to not be able to detect SSBs from the network node. The network node is the network node disclosed herein, such as network node 400 of FIG. 1, FIG. 2, and FIG. 6, or a Non-Terrestrial Network (NTN) node, such as a satellite.

In one or more example methods, the method comprises receiving S101, from an aiding WD, a capability indication indicating to the network node that the aiding WD is capable of transmitting SSB signals. In one or more example methods, the capability indication may indicate that the aiding WD is capable of transmitting SSB signals via the predefined interface. The aiding WD herein may be a WD that is connected to, such as being in Radio Resource Control (RRC) connected mode with, the network node performing the method 100.

In one or more example methods, the method comprises assigning S102 a unique identifier (ID) to the SSB signal. The SSB signal may comprise an ID for identifying the SSB signal. The SSB signal may comprise information about the total number of SSBs in an SSB burst and/or the position of the SSB signal in the SSB burst. Thereby, the discoverable WD, can determine the position of the SSB signal in the burst. Assigning S102 may further comprise associating different SSB signals to the same or to different UL resources, such as RACH resources. The discoverable WD may for example determine, based on the unique identifier, that the SSB signal has been transmitted from the aiding WD.

In one or more example methods, the method comprises determining S103 an Uplink (UL) resource for communicating a response to the SSB signal. The resource may be a time and/or a frequency resource. In one or more example methods, the determining S103 comprises configuring S103A a dedicated resource for communicating reference signals to the network node.

In one or more example methods, the UL resource may be a standard Radio Access Channel (RACH) resource.

In one or more example methods, the network node may configure dedicated Sounding Reference Signal (SRS) resources as UL resources. Based on the dedicated SRS resources, the network node can compute an optimal precoder and thereby establish a strong communication channel with the discoverable WD. A further advantage may be that a timing advance (TA) of the discoverable WD is dependent on the TA of the aiding WD. Thereby, a correlation window at the network node may be reduced, as the discoverable WD will have approximately the same distance to the network node as the aiding WD and the discoverable WD, and the aiding WD therefore likely have similar TA. A dedicated SRS resource can thus be smaller compared to the standard RACH resources which are configured based on that the TA is unknown.

The method 100 comprises transmitting S105, to the aiding WD, a configuration message. The configuration message configures the aiding WD to transmit a Synchronization Signal Block, SSB, signal. The SSB signal is indicative of the UL resource for communicating a response to the SSB signal. In one or more example methods, the SSB signal may comprise a first indication being indicative of the UL resource. In one or more example methods, the SSB signal may comprise a coded sequence indicating the UL resource for communicating with the network. In one or more example methods, the UL resource may be indicated by an index of the received SSB within an SSB burst from the network node.

In one or more example methods, the configuration message is indicative of one or more resources for transmitting the SSB signal. The configuration message may indicate one or more resources, such as one or more time and/or frequency resources, to the aiding WD, in which the aiding WD can transmit the SSB signal to the discoverable WD. In one or more example methods, the configuration message may configure the aiding WD to transmit SSB signals during Downlink (DL) slots. Transmitting the SSB signals in a DL slot may reduce the interference caused by the transmission of the SSB signals.

In one or more example methods, the configuration message configures the SSB signal to be transmitted via the predefined interface. In other words, the network node may configure the aiding WD to transmit the SSB signal via the predefined interface.

In one or more example methods, the configuration message configures the aiding WD to transmit the SSB signal by broadcasting the SSB signal.

In one or more example methods, the UL resource is a dedicated resource for communicating reference signals, such as for communicating an SRS, Physical Random Access Channel (PRACH) preamble and/or a PRACH preamble comprising an SRS, to the network node.

In one or more example methods, the SSB signal is indicative of a time resource, such as an UL time resource, for communicating the response to the SSB signal. The time resource for communicating the response to the SSB signal, may be the time resource in which the discoverable WD is to transmit a response to the SSB signaling.

In one or more example methods, the SSB signal is indicative of a frequency resource, such as an UL frequency resource, for communicating the response to the SSB signal. The frequency resource for communicating the response to the SSB signal, may be the frequency resource in which the discoverable WD is to transmit a response to the SSB signaling.

In one or more example methods, the SSB signal is indicative of a timing advance (TA) for communicating the response to the SSB signal. The TA may be indicative of the time a signal takes to reach the network node from the discoverable WD or vice versa.

In one or more example methods, the SSB signal is indicative of a transmit power control (TPC) parameter for communicating the response to the SSB signal. The TPC parameter may be indicative of a power level that the WD is to use when transmitting a response to the SSB signaling.

In one or more example methods, the SSB signal is indicative of a position of the network node. The position of the network node may indicate to the discoverable WD in which direction the discoverable WD is to transmit signals in response to the SSB signaling.

In one or more example methods, the SSB signal is indicative of ephemeris information. In one or more example methods, such as when the network node is an NTN node, it can be challenging for the discoverable WD to know exactly when to transmit to the NTN node, such as to a satellite. Due to the large propagation distance, which may cause a large TA of the transmitted signal, and/or high speed of the satellite, which may cause an unpredictable Doppler effect of the transmitted signal, hitting the UL resources in the satellite time reference may be difficult. As of 3GPP Rel-17, a WD may use a Global Positioning System (GPS) to derive its position and based on received ephemeris information from the satellite may estimate a TA and/or Doppler information prior to an initial transmission to the satellite. The ephemeris information may be indicative of a location and orbital behavior of the satellite, such as indicative of a trajectory that the satellite is following. According to the current disclosure, the aiding WD already being connected to the satellite may be configured to transmit the SSB comprising the TA and/or ephemeris information of the satellite to the discoverable WD. The ephemeris information may, in one or more example methods, be used for Doppler compensation by the discoverable WD. Thereby, the process of discovering the discoverable WD may be made more robust. In one or more example methods, the TA and the ephemeris information, such as Doppler compensation, may be comprised in a Primary Synchronization Signal (PSS) and/or in a Secondary Synchronization Signal (SSS) of the SSB, and/or in a master information block (MIB) in a Physical Broadcast Channel (PBCH).

In one or more example methods, the SSB signal is indicative of the SSB signal being transmitted by the aiding WD. The SSB signal may indicate to the discoverable WD that the SSB signal has been transmitted from the aiding WD and not from the network node. In one or more example methods, the SSB signal may comprise a second indication, such as a flag, being indicative of the SSB signal being transmitted by the aiding WD. This may indicate to the discoverable WD that the discoverable WD is not to transmit a response to the SSB signaling towards the aiding WD. This may aid the discoverable WD to use a more robust response approach, such as using higher transmit power, increasing a number of repetitions of the transmission, non-optimization of the spatial filtering (such as addressing eigenmodes or more advanced beam-forming). The approach also indicates to the discoverable WD that it cannot directly compare the received power of the SSB transmitted by an aiding WD to the power of the SSBs transmitted by the network node when it selects an SSB to respond to.

In one or more example methods, the SSB signal may comprise a third indication, such as a second flag, being indicative of the where the discoverable WD is to transmit the response to the SSB signal. In one or more example methods, the third indication may indicate whether the node that transmitted the SSB signal is also the receiving node. In one or more example methods, the third indication may indicate that the response to the SSB signal is to be transmitted to the network node. In one or more example methods the third indication may indicate that the response to the SSB signal is to be transmitted to the aiding WD.

In one or more example methods, the SSB signal is indicative of the unique identifier assigned to the SSB signal. The SSB signal may indicate the SSB signals position in an SSB burst to the discoverable WD.

In one or more example methods, the method comprises listening S107 for a signal, such as a reference signal, from the discoverable WD. The method may comprise listening for the signal in the UL resource indicated in the UL resource indicated in the SSB signal.

The signal may be a reference signal, such as an SRS, a PRACH preamble and/or a PRACH preamble comprising an SRS.

In one or more example methods, the network node may, upon detecting a signal from the discoverable WD, determine S109, based on the signal, a precoder for communicating with the discoverable WD in downlink.

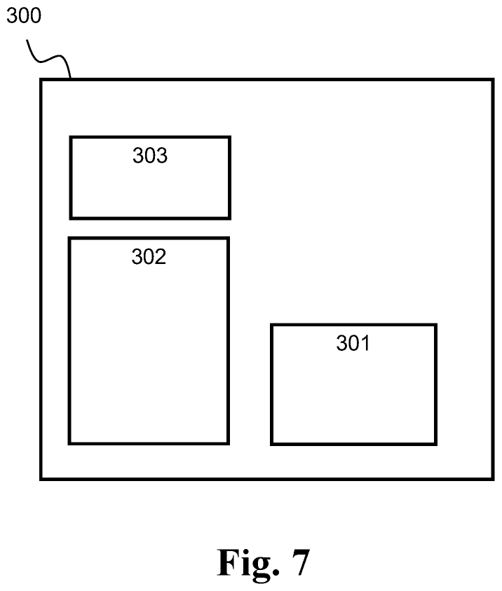

FIG. 4 shows a flow diagram of an example method 200, performed by an aiding wireless device according to the disclosure, for enabling communication between a network node and a discoverable WD. The aiding WD may be a WD that is connected to, such as being in Radio Resource Control (RRC) connected mode with, the network node performing the method 100. The aiding wireless device is a wireless device disclosed herein, such as the wireless device 300 of FIG. 1, FIG. 2, and FIG. 7.

In one or more example methods, the method comprises transmitting S201, to the network node, a capability indication indicating to the network node that the aiding WD is capable of transmitting SSB signals. In one or more example methods, the capability indication may indicate that the aiding WD is capable of transmitting SSB signals via the predefined interface.

The method 200 comprises receiving S203, from the network node, a configuration message, the configuration message being indicative of a resource for transmitting the SSB signal. The configuration message may configure the aiding WD to transmit an SSB signal. In one or more example methods, the configuration message is indicative of one or more resources for transmitting the SSB signal. The configuration message may indicate one or more resources, such as one or more time and/or frequency resources, to the aiding WD, in which the aiding WD can transmit the SSB signal to the discoverable WD. In one or more example methods, the configuration message may configure the aiding WD to transmit SSB signals during Downlink (DL) slots. Transmitting the SSB signals in a DL slot may reduce the interference caused by the transmission of the SSB signals (e.g., there may be no other UL transmissions from, e.g., neighbor WDs close to the discoverable WD). It further enables the SSB transmitted by the aiding WD to be integrated in an SSB-burst and, hence, be jointly transmitted with SSBs transmitted from the network node and/or other aiding WDs.

In one or more example methods, the configuration message configures the SSB signal to be transmitted via the predefined interface. In other words, the network node may configure the aiding WD to transmit the SSB signal via the predefined interface.

In one or more example methods, the configuration message configures the aiding WD to transmit the SSB signal by broadcasting the SSB signal.

The method 200 comprises transmitting S205 the SSB signal based on the received configuration message. In one or more example methods, transmitting S205 comprises transmitting the SSB signal in the indicated resource, such as in the resource indicated in the configuration message. In one or more example methods, transmitting S205 comprises transmitting the SSB signal via the predefined interface. In one or more example methods, transmitting S205 comprises broadcasting S205A the SSB signal, such as broadcasting the SSB signal via the predefined interface.

In one or more example methods, the SSB signal comprises an indication being indicative of the SSB signal being transmitted by the aiding WD. The SSB signal may indicate to the discoverable WD that the SSB signal has been transmitted from the aiding WD and not from the network node. In one or more example methods, the SSB signal may comprise a second indication, such as a flag, being indicative of the SSB signal being transmitted by the aiding WD. This may indicate to the discoverable WD that the discoverable WD is not to transmit a response to the SSB signaling towards the aiding WD. In one or more example methods, the SSB signal is indicative of the unique identifier assigned to the SSB transmitted by the aiding WD. The unique identifier may indicate to the discoverable WD that the SSB signal has been transmitted by the aiding WD.

In one or more example methods, the SSB signal may comprise a third indication, such as a second flag, being indicative of the where the discoverable WD is to transmit the response to the SSB signal. In one or more example methods, the second indication may indicate that the response to the SSB signal is to be transmitted to the network node. In one or more example methods the second indication may indicate that the response to the SSB signal is to be transmitted to the aiding WD.

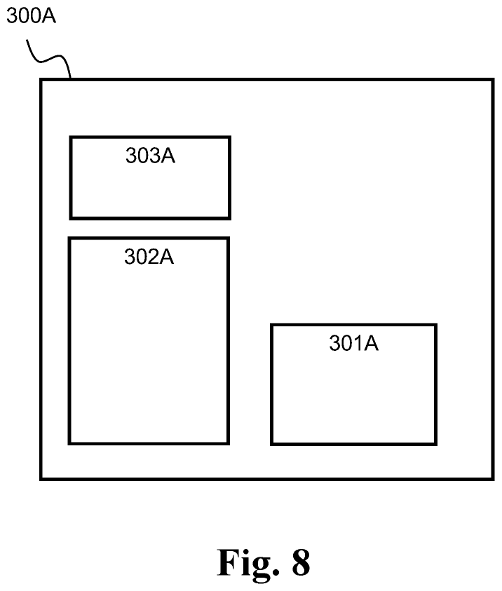

FIG. 5 shows a flow diagram of an example method 500, performed by a discoverable wireless device according to the disclosure, for enabling communication between a discoverable WD and a network node. The discoverable wireless device is a wireless device disclosed herein, such as the wireless device 300A of FIG. 1, FIG. 2, and FIG. 8.

The method 500 comprises receiving S502 an SSB signal. In one or more example methods the SSB signal is received from the aiding WD. In one or more example methods the SSB signal is received via the predefined interface. The SSB signal may be indicative of the UL resource for communicating the response to the SSB signal. In one or more example methods, the SSB signal may comprise a first indication being indicative of the UL resource. In one or more example methods, the SSB signal may comprise a coded sequence indicating the UL resource for communicating the response to the SSB signal. In one or more example methods, the UL resource may be indicated by an index of the received SSB within an SSB burst. Thereby, the receiver of the SSB signal from the aiding WD, such as the discoverable WD, knows when to listen for the “full” SSB burst from the network node.

In one or more example methods, the UL resource is a dedicated resource for communicating reference signals, such as for communicating an SRS, a PRACH preamble (also referred to as Msg1) and/or a PRACH preamble comprising an SRS, to the network node.

In one or more example methods, the SSB signal is indicative of a time resource, such as an UL time resource, for communicating the response to the SSB signal. The time resource for communicating with the network node, may be the time resource in which the discoverable WD is to transmit a response to the SSB signaling.

In one or more example methods, the SSB signal is indicative of a frequency resource, such as an UL frequency resource, for communicating the response to the SSB signal. The frequency resource for communicating the response to the SSB signal, may be the frequency resource in which the discoverable WD is to transmit a response to the SSB signaling.

In one or more example methods, the SSB signal is indicative of a TA for communicating the response to the SSB signal. The TA may be indicative of the time a signal takes to reach the network node from the aiding WD or vice versa. Since the discoverable WD is likely located in the vicinity of the aiding WD, the discoverable WD may use the TA of the aiding WD to transmit its response to the SSB signal. Upon the network node receiving the response to the SSB signal, the network node may respond to the discoverable WD, such as with a Msg2, with a new TA value for the discoverable WD.

In one or more example methods, the SSB signal is indicative of a TPC parameter for communicating the response to the SSB signal. The TPC parameter may be indicative of a power level that the WD is to use when transmitting a response to the SSB signaling.

In one or more example methods, the SSB signal is indicative of a position of the network node.

In one or more example methods, the SSB signal is indicative of ephemeris information, such as ephemeris information of the network node.

In one or more example methods, the SSB signal is indicative of the SSB signal being transmitted by the aiding WD. The SSB signal may indicate to the discoverable WD that the SSB signal has been transmitted from the aiding WD and not from the network node. In one or more example methods, the SSB signal may comprise a second indication, such as a flag, being indicative of the SSB signal being transmitted by the aiding WD. In one or more example methods, the SSB signal is indicative of the unique identifier assigned to the SSB signal. The unique identifier may be indicative of a position of the SSB signal in an SSB burst broadcasted by the network node. The unique identifier may indicate to the discoverable WD that the SSB signal received from the aiding WD has a certain position in an SSB burst from the network node and thereby the discoverable WD may determine when to listen for the SSB burst.

In one or more example methods, the SSB signal is indicative of where the discoverable WD is to transmit the response to the SSB signal. In one or more example methods, the SSB signal may comprise a third indication, such as a second flag, being indicative of the where the discoverable WD is to transmit the response to the SSB signal. In one or more example methods, the second indication may indicate that the response to the SSB signal is to be transmitted to the network node. In one or more example methods the second indication may indicate that the response to the SSB signal is to be transmitted to the aiding WD. This distinction may aid the discoverable WD in the selection of initial TA and/or for selecting a power for its initial transmission.

In one or more example methods, the method comprises determining S504 whether the SSB signal was transmitted by an aiding WD. The discoverable WD may determine that the SSB signal is transmitted by the aiding WD based on the SSB signal, such as based on the second indication, such as the flag, comprised in the SSB signal.

In one or more example methods, determining S504 comprises determining S504A whether the response to the SSB signal is to be transmitted to the network node or to the aiding WD. The discoverable WD may determine whether the response to the SSB signal is to be transmitted to the network node or the aiding WD based on the SSB signal, such as based on the third indication, such as the second flag, comprised in the SSB signal.

Upon determining that the SSB was transmitted by the aiding WD, the discoverable WD may use a more robust approach for transmitting a response to the SSB. The discoverable WD may use one or more of a higher transmit power, an increased number of repetitions of the transmission, and a non-optimal spatial filtering (for example using omni-directional transmission instead of addressing eigenmodes of the SSB or more advanced beam-forming), to ensure that the signal transmitted in response to the SSB reaches the network node.

The method comprises transmitting S506, using the UL resource, one or more signals, such as radio frequency signals. The one or more signals may be transmitted in response to the SSB signal received from the aiding WD. The one or more signals may be reference signals, such as SRSs, a PRACH preamble and/or a PRACH preamble comprising SRS.

In one or more example methods, transmitting of the one or more signals may be based on the received SSB signal, such as based on one or more of the time resource, the frequency resource, the TA, the TPC parameter, the position of the network node and the ephemeris information indicated by the SSB.

FIG. 6 shows a block diagram of an example network node 400 according to the disclosure. The network node 400 comprises memory circuitry 401, processor circuitry 402, and a wireless interface 403. The network node 400 may be configured to perform any of the methods disclosed in FIG. 3. In other words, the network node 400 may be configured for enabling communication with a discoverable WD.

The network node 400 is configured to communicate with a WD, such as the aiding WD and/or the discoverable WD disclosed herein, using a wireless communication system.

The wireless interface 403 is configured for wireless communication via the wireless communication system, such as a 3GPP system, such as a 3GPP system supporting one or more of: New Radio (NR), Narrow-band IoT (NB-IoT), Non-Terrestrial Network (NTN), Long Term Evolution-enhanced Machine Type Communication (LTE-eMTC), and millimeter-wave communications, such as millimeter-wave communications in licensed bands, such as device-to-device millimeter-wave communications in licensed bands.

The network node 400 is configured to transmit, via the wireless interface 403, a configuration message to an aiding WD. The configuration message configures the aiding WD to transmit an SSB signal. The SSB signal being indicative of an UL resource for communicating the response to the SSB signal.

The processor circuitry 402 is optionally configured to perform any of the operations disclosed in FIG. 3 (such as any one or more of S101, S102, S103, S103A, S105, S107, S109). The operations of the network node 400 may be embodied in the form of executable logic routines (for example, lines of code, software programs, etc.) that are stored on a non-transitory computer readable medium (for example, memory circuitry 401) and are executed by processor circuitry 402).

Furthermore, the operations of the network node 400 may be considered a method that the network node 400 is configured to carry out. Also, while the described functions and operations may be implemented in software, such functionality may also be carried out via dedicated hardware or firmware, or some combination of hardware, firmware and/or software.

The memory circuitry 401 may be one or more of a buffer, a flash memory, a hard drive, a removable media, a volatile memory, a non-volatile memory, a random access memory (RAM), or other suitable device. In a typical arrangement, memory circuitry 401 may include a non-volatile memory for long term data storage and a volatile memory that functions as system memory for processor circuitry 402. Memory circuitry 401 may exchange data with processor circuitry 402 over a data bus. Control lines and an address bus between memory circuitry 401 and processor circuitry 402 also may be present (not shown in FIG. 6). Memory circuitry 401 is considered a non-transitory computer readable medium.

The memory circuitry 401 may be configured to store information (such as information indicative of UL resources, TA parameters, TPC parameters, a position of the network node and/or a unique identifier of the SSB signal) in a part of the memory.

FIG. 7 shows a block diagram of an example aiding wireless device 300 according to the disclosure. The aiding wireless device 300 comprises memory circuitry 301, processor circuitry 302, and a wireless interface 303. The aiding wireless device 300 may be configured to perform any of the methods disclosed in FIG. 4. In other words, the wireless device 300 may be configured for enabling communication between a network node and a discoverable WD.

The aiding wireless device 300 is configured to communicate with a network node, such as the network node 400 disclosed herein, and/or with a wireless device, such as the discoverable WD 300A disclosed herein, using a wireless communication system.

The wireless device 300 is configured to receive (such as via the wireless interface 303), from the network node, a configuration message, wherein the configuration message configures the aiding WD to transmit an SSB signal, the SSB signal being indicative of an UL resource for communicating the response to the SSB signal.

The wireless device 300 is configured to transmit (such as via the wireless interface 303) the SSB signal based on the received configuration message.

The wireless interface 303 is configured for wireless communications via a wireless communication system, such as a 3GPP system, such as a 3GPP system supporting one or more of: New Radio (NR), Narrow-band IoT (NB-IoT), Non-Terrestrial Network (NTN), Long Term Evolution-enhanced Machine Type Communication (LTE-eMTC), and millimeter-wave communications, such as millimeter-wave communications in licensed bands, such as device-to-device millimeter-wave communications in licensed bands.

The wireless device 300 is optionally configured to perform any of the operations disclosed in FIG. 4 (such as any one or more of S201, S203, S205, S205A). The operations of the wireless device 300 may be embodied in the form of executable logic routines (for example, lines of code, software programs, etc.) that are stored on a non-transitory computer readable medium (for example, memory circuitry 301) and are executed by processor circuitry 302).

Furthermore, the operations of the wireless device 300 may be considered a method that the wireless device 300 is configured to carry out. Also, while the described functions and operations may be implemented in software, such functionality may also be carried out via dedicated hardware or firmware, or some combination of hardware, firmware and/or software.

Memory circuitry 301 may be one or more of a buffer, a flash memory, a hard drive, a removable media, a volatile memory, a non-volatile memory, a random access memory (RAM), or other suitable device. In a typical arrangement, memory circuitry 301 may include a non-volatile memory for long term data storage and a volatile memory that functions as system memory for processor circuitry 302. Memory circuitry 301 may exchange data with processor circuitry 302 over a data bus. Control lines and an address bus between memory circuitry 301 and processor circuitry 302 also may be present (not shown in FIG. 7). Memory circuitry 301 is considered a non-transitory computer readable medium.

Memory circuitry 301 may be configured to store information (such as information indicative of resources for transmitting the SSB signal) in a part of the memory.

FIG. 8 shows a block diagram of an example discoverable wireless device 300A according to the disclosure. The discoverable wireless device 300A comprises memory circuitry 301A, processor circuitry 302A, and a wireless interface 303A. The discoverable wireless device 300A may be configured to perform any of the methods disclosed in FIG. 5. In other words, the discoverable wireless device 300A may be configured for enabling communication between the discoverable WD and a network node.

The discoverable wireless device 300A is configured to communicate with a network node, such as the network node 400 disclosed herein, and/or with a wireless device, such as the aiding WD 300 disclosed herein, using a wireless communication system.

The discoverable wireless device 300A is configured to receive (such as via the wireless interface 303A), an SSB signal, the SSB signal being indicative of an UL resource for communicating the response to the SSB signal.

The discoverable wireless device 300A may be configured to determine (such as via the processor circuitry 302A) that the SSB signal was transmitted by the aiding WD.

The discoverable wireless device 300A is configured to transmit (such as via the wireless interface 303A), using the UL resource, one or more signals, such as one or more radio frequency signals.

The wireless interface 303A is configured for wireless communications via a wireless communication system, such as a 3GPP system, such as a 3GPP system supporting one or more of: New Radio (NR), Narrow-band IoT (NB-IoT), Non-Terrestrial Network (NTN), Long Term Evolution-enhanced Machine Type Communication (LTE-eMTC), and millimeter-wave communications, such as millimeter-wave communications in licensed bands, such as device-to-device millimeter-wave communications in licensed bands.

The discoverable wireless device 300A is optionally configured to perform any of the operations disclosed in FIG. 4 (such as any one or more of S502, S504, S506). The operations of the discoverable wireless device 300A may be embodied in the form of executable logic routines (for example, lines of code, software programs, etc.) that are stored on a non-transitory computer readable medium (for example, memory circuitry 301A) and are executed by processor circuitry 302A).

Furthermore, the operations of the discoverable wireless device 300A may be considered a method that the discoverable wireless device 300A is configured to carry out. Also, while the described functions and operations may be implemented in software, such functionality may also be carried out via dedicated hardware or firmware, or some combination of hardware, firmware and/or software.

The memory circuitry 301A may be one or more of a buffer, a flash memory, a hard drive, a removable media, a volatile memory, a non-volatile memory, a random access memory (RAM), or other suitable device. In a typical arrangement, memory circuitry 301A may include a non-volatile memory for long term data storage and a volatile memory that functions as system memory for processor circuitry 302A. Memory circuitry 301A may exchange data with processor circuitry 302A over a data bus. Control lines and an address bus between memory circuitry 301A and processor circuitry 302A also may be present (not shown in FIG. 8). Memory circuitry 301A is considered a non-transitory computer readable medium.

The memory circuitry 301A may be configured to store information (such as information indicative of UL resources, TA parameters, TPC parameters, a position of the network node and/or a unique identifier of the SSB signal) in a part of the memory.

Examples of methods and products (network node, aiding wireless device and discoverable wireless device) according to the disclosure are set out in the following items:
Item 1. A method performed by a network node, for enabling communication with a discoverable wireless device, WD, wherein the method comprises:
   transmitting (S103), to an aiding WD, a configuration message, wherein the configuration message configures the aiding WD to transmit a Synchronization Signal Block, SSB, signal, the SSB signal being indicative of an Uplink, UL, resource for communicating a response to the SSB signal.
Item 2. The method according to Item 1, wherein the configuration message is indicative of one or more resources for transmitting the SSB signal.
Item 3. The method according to any of the previous Items, wherein the configuration message configures the aiding WD to transmit the SSB signal by broadcasting the SSB signal.
Item 4. The method according to any one of the previous Items, wherein the UL resource is a dedicated resource for communicating reference signals to the network node.
Item 5. The method according to any of the previous Items, wherein the SSB signal is indicative of one or more of a time resource for communicating the response to the SSB signal, a frequency resource for communicating the response to the SSB signal, a timing advance, TA, for communicating the response to the SSB signal, a transmit power control, TPC, parameter for communicating the response to the SSB signal, and a position of the network node.
Item 6. The method according to any one of the previous Items, wherein the SSB signal is indicative of the SSB signal being transmitted by the aiding WD.
Item 7. The method according to Item 6, wherein the SSB signal is indicative of a unique identifier assigned to the SSB signal.
Item 8. The method according to Item 7, wherein the method further comprises:
   assigning (S102) the unique identifier to the SSB signal.
Item 9. The method according to any one of the previous Items, wherein the SSB signal is indicative of where the discoverable WD is to transmit the response to the SSB signal.
Item 10. The method according to any one of the previous Items, wherein the configuration message configures the SSB signal to be transmitted via a predefined interface.
Item 11. The method according to any one of the previous Items, wherein the method further comprises:
   receiving (S101), from the aiding WD, a capability indication indicating to the network node that the aiding WD is capable of transmitting SSB signals.
Item 12. The method according to any one of the previous Items, wherein the method further comprises:
   determining (S105) the UL resource for communicating the response to the SSB signal.
Item 13. The method according to Item 12, wherein determining (S105) comprises configuring (S105A) a dedicated resource for communicating reference signals to the network node.
Item 14. The method according to any one of the previous Items, wherein the method further comprises:
   listening (S107) for a signal from the discoverable WD.
Item 15. A method performed by an aiding wireless device, WD, for enabling communication between a network node and a discoverable WD, wherein the method comprises:
   receiving (S203), from the network node, a configuration message, wherein the configuration message configures the aiding WD to transmit a Synchronization Signal Block, SSB, signal, the SSB signal being indicative of an Uplink, UL, resource for communicating a response to the SSB signal, and
   transmitting (S205) the SSB signal based on the received configuration message.
Item 16. The method according to Item 15, wherein the configuration message is indicative of a resource for transmitting the SSB signal, and wherein transmitting (S205) comprises transmitting the SSB signal in the indicated resource.
Item 17. The method according to either of Items 15 or 16, wherein transmitting (S205) comprises transmitting the SSB signal via a predefined interface.
Item 18. The method according to any of the Items 15 to 17, wherein transmitting (S205) comprises broadcasting (S205A) the SSB signal.
Item 19. The method according to any of the Items 15 to 18, wherein the SSB signal is indicative of one or more of:
   a time resource for communicating the response to the SSB signal,
   a timing advance, TA, for communicating the response to the SSB signal,
   a transmit power control, TPC, parameter for communicating the response to the SSB signal,
   a frequency resource for communicating the response to the SSB signal, and
   a position of the network node.
Item 20. The method according to any one of the Items 15 to 19, wherein the SSB signal comprises an indication being indicative of the SSB signal being transmitted by the aiding WD.
Item 21. A method performed by a discoverable wireless device, WD, for enabling communication between the discoverable WD and a network node, the method comprising:
   receiving (S502) a Synchronisation Signal Block, SSB, signal, the SSB signal being indicative of an Uplink, UL, resource for communicating the response to the SSB signal,
   determining (S504) that the SSB signal was transmitted by an aiding WD, and
   transmitting (S506), using the UL resource, one or more radio frequency signals.
Item 22. A network node comprising memory circuitry, processor circuitry, and a wireless interface, wherein the network node is configured to perform any of the methods according to any of Items 1-14.
Item 23. An aiding wireless device comprising memory circuitry, processor circuitry, and a wireless interface, wherein the aiding wireless device is configured to perform any of the methods according to any of Items 15-20.
Item 24. A discoverable wireless device comprising memory circuitry, processor circuitry, and a wireless interface, wherein the discoverable wireless device is configured to perform any of the methods according to Item 21.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1-8 comprise some circuitries or operations which are illustrated with a solid line and some circuitries, components, features, or operations which are illustrated with a dashed line. Circuitries or operations which are comprised in a solid line are circuitries, components, features or operations which are comprised in the broadest example. Circuitries, components, features, or operations which are comprised in a dashed line are examples which may be comprised in, or a part of, or are further circuitries, components, features, or operations which may be taken in addition to circuitries, components, features, or operations of the solid line examples. It should be appreciated that these operations need not be performed in order presented. Furthermore, it should be appreciated that not all of the operations need to be performed. The example operations may be performed in any order and in any combination. It should be appreciated that these operations need not be performed in order presented. Circuitries, components, features, or operations which are comprised in a dashed line may be considered optional.

Other operations that are not described herein can be incorporated in the example operations. For example, one or more additional operations can be performed before, after, simultaneously, or between any of the described operations.

Certain features discussed above as separate implementations can also be implemented in combination as a single implementation. Conversely, features described as a single implementation can also be implemented in multiple implementations separately or in any suitable sub-combination. Moreover, although features may be described above as acting in certain combinations, one or more features from a claimed combination can, in some cases, be excised from the combination, and the combination may be claimed as any sub-combination or variation of any sub-combination

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than or equal to 10% of, within less than or equal to 5% of, within less than or equal to 1% of, within less than or equal to 0.1% of, and within less than or equal to 0.01% of the stated amount. If the stated amount is 0 (e.g., none, having no), the above recited ranges can be specific ranges, and not within a particular % of the value.

The various example methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method performed by a network node, for enabling communication with a discoverable wireless device (WD) wherein the method comprises:
transmitting, to an aiding WD, a configuration message, wherein the configuration message configures the aiding WD to transmit a Synchronization Signal Block (SSB) signal, the SSB signal being indicative of an Uplink (UL) resource for communicating a response to the SSB signal.

2. The method according to claim 1, wherein the configuration message is indicative of one or more resources for transmitting the SSB signal.

3. The method according to claim 1, wherein the configuration message configures the aiding WD to transmit the SSB signal by broadcasting the SSB signal.

4. The method according to claim 1, wherein the UL resource is a dedicated resource for communicating reference signals to the network node.

5. The method according to claim 1, wherein the SSB signal is indicative of one or more of:
a time resource for communicating the response to the SSB signal,
a frequency resource for communicating the response to the SSB signal,
a timing advance (TA) for communicating the response to the SSB signal,
a transmit power control (TPC) parameter for communicating the response to the SSB signal, and
a position of the network node.

6. The method according to claim 1, wherein the SSB signal is indicative of the SSB signal being transmitted by the aiding WD.

7. The method according to claim 6, wherein the SSB signal is indicative of a unique identifier assigned to the SSB signal.

8. The method according to claim 7, wherein the method further comprises:
assigning the unique identifier to the SSB signal.

9. The method according to claim 1, wherein the SSB signal is indicative of where the discoverable WD is to transmit the response to the SSB signal.

10. The method according to claim 1, wherein the configuration message configures the SSB signal to be transmitted via a predefined interface.

11. The method according to claim 1, wherein the method further comprises:
receiving, from the aiding WD, a capability indication indicating to the network node that the aiding WD is capable of transmitting SSB signals.

12. The method according to claim 1, wherein the method further comprises:
determining the UL resource for communicating the response to the SSB signal.

13. The method according to claim 12, wherein determining comprises configuring a dedicated resource for communicating reference signals to the network node.

14. The method according to claim 1, wherein the method further comprises:
listening for a signal from the discoverable WD.

15. A method performed by an aiding wireless device (WD) for enabling communication between a network node and a discoverable WD wherein the method comprises:
receiving, from the network node, a configuration message, wherein the configuration message configures the aiding WD to transmit a Synchronization Signal Block (SSB) signal, the SSB signal being indicative of an Uplink (UL) resource for communicating a response to the SSB signal, and
transmitting the SSB signal based on the received configuration message.

16. The method according to claim 15, wherein the configuration message is indicative of a resource for transmitting the SSB signal, and wherein transmitting comprises transmitting the SSB signal in the indicated resource.

17. The method according to claim 15, wherein transmitting comprises transmitting the SSB signal via a predefined interface.

18. The method according to claim 15, wherein transmitting comprises broadcasting the SSB signal.

19. The method according to claim 15, wherein the SSB signal is indicative of one or more of:
a time resource for communicating the response to the SSB signal,
a timing advance (TA) for communicating the response to the SSB signal,
a transmit power control (TPC) parameter for communicating the response to the SSB signal,
a frequency resource for communicating the response to the SSB signal, and
a position of the network node.

20. (canceled)

21. A method performed by a discoverable wireless device (WD) for enabling communication between the discoverable WD and a network node, the method comprising:
receiving a Synchronisation Signal Block (SSB) signal, the SSB signal being indicative of an Uplink (UL) resource for communicating the response to the SSB signal,
determining that the SSB signal was transmitted by an aiding WD, and
transmitting, using the UL resource, one or more radio frequency signals.

22-24. (canceled)
